(19) United States
(12) Patent Application Publication
(10) Pub. No.: US 2022/0379502 A1
(43) Pub. Date: Dec. 1, 2022

(54) KNIFE AND TOOL

(71) Applicant: GLOBE CORPORATION, Ibaraki (JP)

(72) Inventors: Kengo HORIUCHI, Ibaraki (JP); Konosuke HORIUCHI, Ibaraki (JP); Ryohei WANO, Ibaraki (JP)

(21) Appl. No.: 17/619,544

(22) PCT Filed: Jan. 5, 2021
(86) PCT No.: PCT/JP2021/000136

§ 371 Date: Dec. 15, 2021

(30) Foreign Application Priority Data
Jan. 11, 2020 (JP) 2020-003289

(51) Int. Cl. B26B 5/00; B26B 1/02

(52) U.S. Cl. CPC B26B 5/00; B26B 1/02

(57) ABSTRACT

Provided is a knife facilitating haft replacement to suit a person's preference and purpose of use. On the front side of a tang 3 extending in the front-rear direction, a protrusion portion 7 capable of biting into a haft 50 made of, for example, a wooden rod such as a tree branch is provided so as to be separated from the tang 3 and protrude to the rear side of the tang 3. A first receiving portion 8 receiving the haft 50 with the protrusion portion 7 biting into the haft 50 is provided on the rear side of the tang 3. The end surface of one end portion of the haft 50 is bitten by being pushed in from the protruding end side of the protrusion portion 7 toward the front side of the tang 3. With the protrusion portion 7 biting into the haft 50, the other end portion side of the haft 50 extending to the rear side of the tang 3 is received by the first receiving portion 8. As a result, the haft 50 is attached to a knife 1. As a result, a structure for connecting the tang to the haft 50 is unnecessary and a person can easily replace the haft 50 to suit his or her preference and purpose of use.

### TECHNICAL FIELD

The present invention relates to a knife mainly used outdoors and the structure of a part where a haft is attached to a knife tang.

### BACKGROUND ART

As for the knife disclosed in Patent Document 1, the tang (core) of the knife inserted in a haft (grip) is fixed by a set screw screwed in the screw hole provided in the haft. As a result, both the tang and the haft require a structure for connection and a person using the knife cannot easily replace the haft to suit his or her preference and purpose of use.

### CITATION LIST

### Patent Document

Patent Document 1: JP 2003-134988 A

### SUMMARY OF THE INVENTION

### Problem to be Solved by the Invention

The invention has been made in view of the related art, and an object of the invention is to provide a knife that does not require a structure for haft-tang connection and allows a person using the knife to easily perform haft replacement to suit his or her preference and purpose of use.

### Means for Solving Problem

The invention relates to a knife (tool) in which a knife blade (tip member) and a tang (attachment main body portion) are integrated in a plate shape or a knife (tool) in which a knife blade (tip member) and a tang (attachment main body portion) are foldably connected, in which a protrusion portion capable of biting into a haft is provided on a front side of the tang (attachment main body portion) so as to be separated from the tang (attachment main body portion) and protrude to a rear side of the tang (attachment main body portion) and a receiving portion receiving the haft with the protrusion portion biting into the haft is provided on the rear side of the tang (attachment main body portion), or a knife (tool) in which a knife blade (tip member) and a tang (attachment main body portion) are divided in a front-rear direction and foldably connected to a sheath portion, in which a protrusion portion capable of biting into a haft is connected to the sheath portion foldably and coaxially with the knife blade (tip member) and the tang (attachment main body portion) is unfolded from the sheath portion so as to receive the haft with the protrusion portion biting into the haft.

### Effect of the Invention

In the knife of the invention in which the knife blade and the tang are integrated in a plate shape or the knife blade and the tang are foldably connected, the protrusion portion capable of biting into the haft is provided on the front side of the tang so as to be separated from the tang and protrude to the rear side of the tang and the receiving portion receiving the haft with the protrusion portion biting into the haft is provided on the rear side of the tang. As a result, a structure for haft-tang connection is unnecessary and a person using the knife can easily perform haft replacement to suit his or her preference and purpose of use.

In addition, in the knife of the invention in which the knife blade and the tang are divided in the front-rear direction and foldably connected to the sheath portion, the protrusion portion capable of biting into the haft is connected to the sheath portion foldably and coaxially with the knife blade and the tang is unfolded from the sheath portion so as to receive the haft with the protrusion portion biting into the haft. As a result, a structure for haft-tang connection is unnecessary and a person using the knife can easily perform haft replacement to suit his or her preference and purpose of use.

### BRIEF DESCRIPTION OF DRAWINGS

FIG. 1 is a side view illustrating a knife according to a first embodiment;

FIG. 2 is a bottom view of the knife according to the first embodiment as viewed from the arrow A direction in FIG. 1;

FIG. 3 is a rear view of the knife according to the first embodiment as viewed from the arrow B direction in FIG. 1;

FIG. 4 is a side view illustrating a knife according to a second embodiment;

FIG. 5 is a bottom view of the knife according to the second embodiment as viewed from the arrow A direction in FIG. 4;

FIG. 6 is a cross-sectional view taken along line C-C in FIG. 4;

FIG. 7 is a side view illustrating a knife according to a third embodiment;

FIG. 8 is a side view illustrating a state where a knife according to a fourth embodiment is unfolded;

FIG. 9 is a side view illustrating a state where the knife according to the fourth embodiment is folded;

FIG. 10 is a bottom view of the knife according to the fourth embodiment as viewed from the arrow A direction in FIG. 8;

FIG. 11 is a side view illustrating a knife according to a fifth embodiment;

FIG. 12 is a bottom view of the knife according to the fifth embodiment as viewed from the arrow A direction in FIG. 11;

FIG. 13 is a side view illustrating a knife according to a sixth embodiment;

FIG. 14 is a side view illustrating the knife according to the first embodiment and the structure of a detachable protrusion portion; and

FIG. 15 is a side view illustrating the knife according to the first embodiment and the structure of a detachable protrusion portion.

### MODE(S) FOR CARRYING OUT THE INVENTION

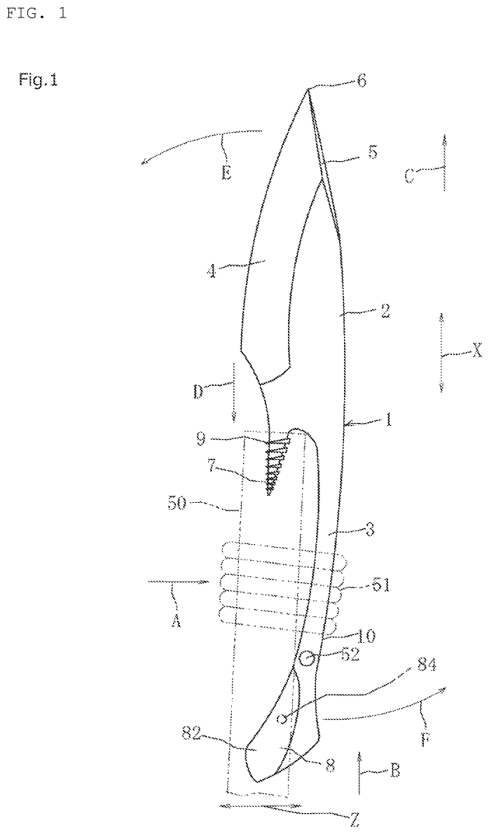

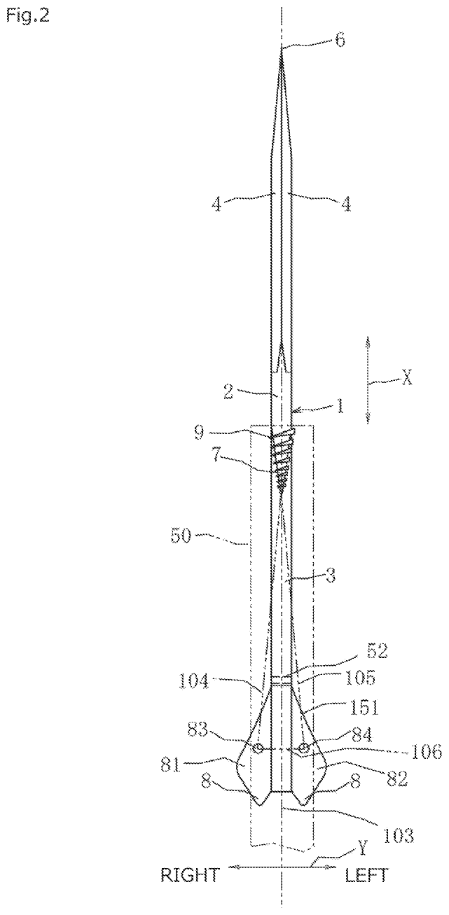

A knife 1 according to a first embodiment illustrated in FIG. 1 exemplifies a spear knife used like a spear with a haft 50 attached, and a knife blade 2 and a tang 3 are integrated in a plate shape. The knife blade 2 has a plate shape extending from one end portion to the other end portion. The knife blade 2 is provided with blades 4 and 5 as double-edged blades in the upper and lower portions of the knife blade 2 in a direction intersecting with a longitudinal direction X. The knife blade 2 is provided with a point 6 as a cutting edge at the part where the double-edged blades 4 and 5 in the upper and lower portions intersect with each other. The tang 3 has a plate shape extending from one end portion of the knife blade 2 in the front-rear direction as the longitudinal direction X of the knife blade 2. It should be noted that the blade 5 may not be provided. In addition, as illustrated in FIG. 2, the blade 4 and a protrusion portion 7 are provided on a center line 103. Since the blade 4 and the protrusion portion 7 are disposed in a straight line, even in a case where a piercing-direction force is applied to the knife 1, the force can be transmitted to the haft 50 via the protrusion portion 7 without deviating in the right-left direction.

On the front side of the tang 3 extending in the front-rear direction, the protrusion portion 7 capable of biting into the haft 50 made of, for example, a wooden rod such as a tree branch is provided so as to separate from the tang 3 and protrude to the rear side of the tang 3. On the rear side of the tang 3, a first receiving portion 8 receiving the haft 50 with the protrusion portion 7 biting into the haft 50 is provided.

The first receiving portion 8 is provided with a first right side receiving portion 81 and a first left side receiving portion 82. The first right side receiving portion 81 is provided with a first right protrusion portion 83. The first left side receiving portion 82 is provided with a first left protrusion portion 84. As for the first receiving portion 8, the first right side receiving portion 81 and the first left side receiving portion 82 form a set of two. The first right protrusion portion 83 is provided at a position to the right of the blade 4 and the protrusion portion 7. In addition, the first left protrusion portion 84 is provided at a position to the left of the blade 4 and the protrusion portion 7. The first right protrusion portion 83 and the first left protrusion portion 84 are provided so as to be bilaterally symmetrical with respect to the center line 103.

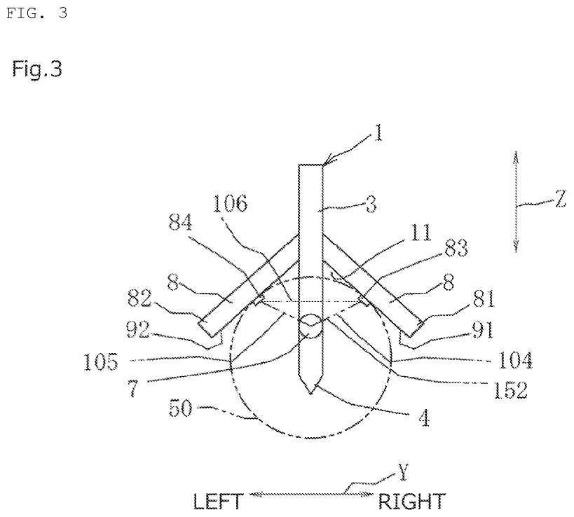

As illustrated in FIG. 3, the first receiving portion 8 protruding on both the right and left sides of the tang 3 is opened downward from the tang 3 side to the protrusion side. A downward recess portion 11 is formed as a result. The recess portion 11 supports the haft 50 so as not to sway in the right-left direction.

Returning to FIG. 1, a case where the haft 50 is attached to the knife 1 will be described. The end surface of one end portion of the haft 50 is bitten by being pushed in from the protruding end side of the protrusion portion 7 toward the front side of the tang 3. With the protrusion portion 7 biting into the haft 50, the other end portion side of the haft 50 extending to the rear side of the tang 3 is received by the first receiving portion 8. As a result, the haft 50 is attached to the knife 1. As a result, a structure for connecting the tang to the haft 50 is unnecessary and a person using the knife 1 can easily replace the haft 50 to suit his or her preference and purpose of use. The knife 1 can be used as a spear if the haft 50 has the shape of a long rod. If the haft 50 is a short piece of wood or the like, the person can hold the tang 3 and the haft 50 and use the knife 1 like a knife. A rod with a non-smooth peripheral surface such as a tree branch can be used for the haft 50. As for the thickness of the haft 50, no precise dimensional thickness is required and there is a degree of freedom in terms of the thickness of the tree branch attached to the knife 1.

A bottom-view triangle 151 drawn by a virtual line 104 connecting the protrusion portion 7 and the first right protrusion portion 83, a virtual line 105 connecting the protrusion portion 7 and the first left protrusion portion 84, and a virtual line 106 connecting the first right protrusion portion 83 and the first left protrusion portion 84 is formed as illustrated in FIG. 2. The knife 1 and the haft 50 are stably fixed by forming the triangle 151 by fixing at the three places of the protrusion portion 7, the first right protrusion portion 83, and the first left protrusion portion 84. It should be noted that the triangle 151 is preferably an isosceles triangle in which the virtual line 104 and the virtual line 105 have the same length and the knife 1 and the haft 50 are evenly fixed in the right-left direction to ensure a stable connection.

Further, as illustrated in FIG. 3, in a case where the knife 1 is viewed from the back surface in the direction of the arrow B illustrated in FIG. 1 and a rear-view triangle 152 drawn by the virtual line 104 connecting the protrusion portion 7 and the first right protrusion portion 83, the virtual line 105 connecting the protrusion portion 7 and the first left protrusion portion 84, and the virtual line 106 connecting the first right protrusion portion 83 and the first left protrusion portion 84 is formed, the haft 50 and the knife 1 are more stably connected, which is preferable, by forming the triangle 152 by fixing at the three places of the protrusion portion 7, the first right protrusion portion 83, and the first left protrusion portion 84. In this case, more stability is ensured than in a case where the protrusion portion 7, the first right protrusion portion 83, and the first left protrusion portion 84 are disposed so as to be arranged in a straight line in the right-left direction. The rear-view triangle 152 is preferably an isosceles triangle. Although a case where the protrusion portion 7 is provided above the first right protrusion portion 83 and the first left protrusion portion 84 is exemplified in FIG. 3, a stable connection can be ensured, even in a case where the protrusion portion 7 is provided below the first right protrusion portion 83 and the first left protrusion portion 84, if the rear-view triangle 152 is formed.

Returning to FIG. 1, in a case where the knife 1 is used so as to pierce in the arrow C direction with the haft 50 attached to the knife 1, a force is applied in the arrow D direction to the protruding end of the protrusion portion 7 when the point 6 hits an object. As a result, the end surface of one end portion of the haft 50 is pushed in toward the front side of the tang 3. In addition, in a case where the knife 1 is used so as to swing down in the arrow E direction with the haft 50 attached to the knife 1, the protrusion portion 7 becomes a fulcrum and a force is applied in the arrow F direction when the blade 4 hits an object. As a result, the other end portion side of the haft 50 extending to the rear side of the tang 3 is received by the first receiving portion 8. If the bottom-view triangle 151 is formed, the knife 1 and the haft 50 can be stably fixed. If the bottom-view triangle 151 and the rear-view triangle 152 are formed together, the knife 1 and the haft 50 are fixed with more stability.

In the embodiment of the invention, the first right side receiving portion 81 and the first left side receiving portion 82 of the first receiving portion 8 protrude from the tang 3 on both the right and left sides and are bilaterally symmetrical with respect to the center line 103 as illustrated in FIG. 2. Further, a case where the first right protrusion portion 83 and the first left protrusion portion 84 are provided at positions bilaterally symmetrical with respect to the center line 103 is exemplified. It should be noted that the right and left sides of the first receiving portion 8 are in a lateral direction Y intersecting with the front-rear direction as the longitudinal direction X of the knife blade 2 in the tang 3.

However, the first right side receiving portion 81 and the first left side receiving portion 82 may protrude from positions deviating forward and backward in the longitudinal direction X. Even in such a case, the bottom-view triangle 151 drawn by the virtual line 104, the virtual line 105, and the virtual line 106 is an isosceles triangle, which is more preferable, if the first right protrusion portion 83 and the first left protrusion portion 84 are provided at positions bilaterally symmetrical with respect to the center line 103. By providing the first right protrusion portion 83 and the first left protrusion portion 84, the contact part between the peripheral surface of the haft 50 and the knife 1 can be identified. Then, the vertex parts of the bottom-view triangle 151 and the rear-view triangle 152 can be determined even in a case where a rod with a non-smooth peripheral surface such as a tree branch fallen outdoors is used for the haft 50.

In addition, a surface 91 of the first right side receiving portion 81 on the side of contact with the haft 50 and a surface 92 of the first left side receiving portion 82 on the side of contact with the haft 50, which are illustrated in FIG. 3, may be flat surfaces without providing the first right protrusion portion 83 and the first left protrusion portion 84. In another structure, the flat surface of the first right side receiving portion 81 on the side of contact with the haft 50 may be in contact with the peripheral surface of the haft 50, the flat surface of the first left side receiving portion 82 on the side of contact with the haft 50 may be in contact with the peripheral surface of the haft 50, and the first receiving portion 8 may be capable of receiving the haft 50 evenly in the right-left direction. In other words, the same structure as a holder for a cylindrical body such as a round bar called a V block or a bevel stand may be used as the first receiving portion 8. Even in such a case, if the contact part between the haft 50 and the surface 91 of the first right side receiving portion 81 on the side of contact with the haft 50 is on the side to the right of the blade 4 and the protrusion portion 7 and the contact part between the haft 50 and the surface 92 of the first left side receiving portion 82 on the side of contact with the haft 50 is on the side to the left of the blade 4 and the protrusion portion 7, the bottom-view triangle 151 and/or the rear-view triangle 152 are formed at the three places of the two contact parts and the protrusion portion 7. As a result, the knife 1 and the haft 50 can be connected and a stable connection is possible.

In FIG. 1, the protrusion portion 7 is tapered toward the protrusion side, and thus the protrusion portion 7 easily bites into the end surface of one end portion of the haft 50. In addition, in FIG. 1, the outer surface of the tapered protrusion portion 7 is provided with a male screw 9. Accordingly, in a case where the protrusion portion 7 bites into one end portion of the haft 50, the male screw 9 is screwed and bites inward from the tip of one end portion of the haft 50 like a wood screw or a tapping screw by rotating one or both of the knife 1 and the haft 50. As a result, the haft 50 is unlikely to be disconnected from the protrusion portion 7.

If both the tang 3 and the haft 50 are tied from the outside by a tying member 51 such as a string and a rope with the haft 50 supported by the protrusion portion 7 and the first receiving portion 8 and attached to the tang 3 as described above, fixing can be performed with the first right protrusion portion 83 and the first left protrusion portion 84 biting into the peripheral surface of the haft 50. As a result, the attachment of the haft 50 to the tang 3 is stable. In a case where both the haft 50 and the tang 3 are tied by the tying member 51 in this manner, one end portion of the haft 50 is bitten by the protrusion portion 7 and temporarily fixed, and thus both the haft 50 and the tang 3 are easily tied by the tying member 51.

In addition, if a through hole 52 for penetration in the right-left direction of the arrow Y illustrated in FIG. 2 is provided at the rear part of the tang 3, the haft 50 and the tang 3 can be easily tied by the tying member 51 by passing one end side of the tying member 51 through the through hole 52. It should be noted that a plurality of the through holes 52 may be provided and the number may be two, three, or four or more.

In a case where both the tang 3 and the haft 50 are tied from the outside by the tying member 51, a back portion 10 of the tang 3 may be provided with a projecting or recessed non-slip portion (not illustrated) for the tying member 51 (not illustrated). Then, the tying member 51 is not disconnected from the tang 3 and the tang 3 and the haft 50 can be appropriately tied.

Although a case where the tang 3 is provided with one first receiving portion 8 is exemplified in the embodiment of the invention, a plurality of the first receiving portions 8 may be individually and separately provided in front of and behind the tang 3.

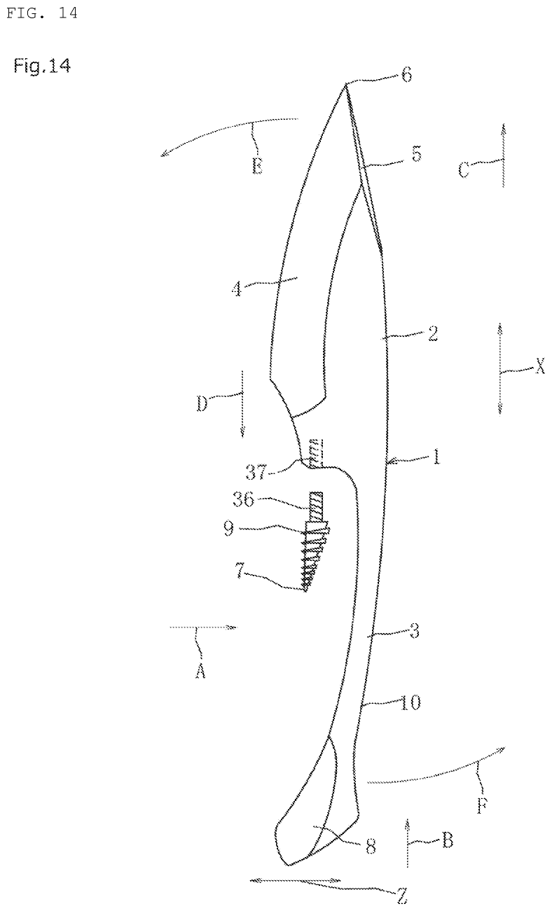

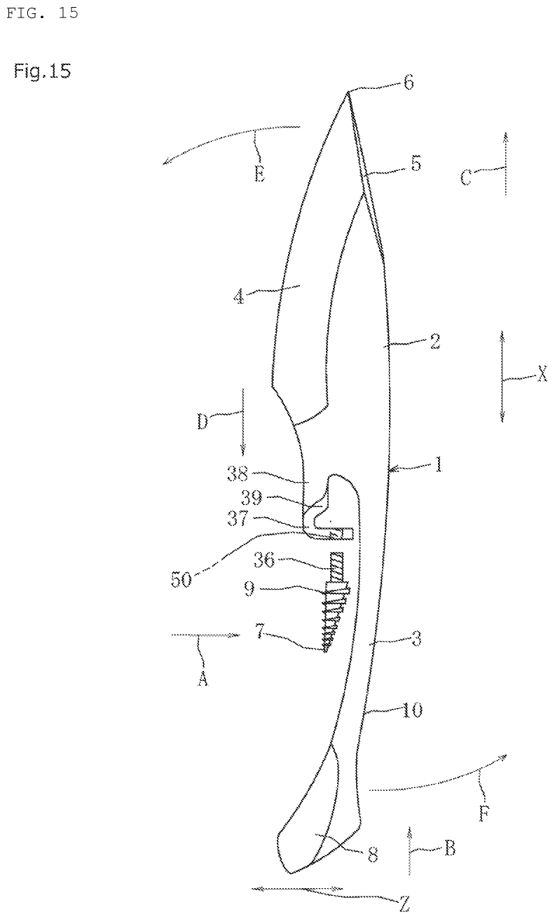

In addition, the protrusion portion 7 may be provided so as to be detachable from the front part of the tang 3. Replacement is possible, which is preferable, in a case where the sharpness of the protrusion portion 7 is lost. Applicable is a structure provided with a connecting portion 36 provided with a male screw protruding to the front of the protrusion portion 7 and a connected portion 37 provided with a female screw in a hole recessed forward from the front part of the tang 3 as illustrated in FIG. 14. It should be noted that a plate-shaped portion 38 protruding from the front to the rear of the tang 3 is provided as illustrated in FIG. 15. The plate-shaped portion 38 and the tang 3 are provided in an integral plate shape. In another structure, a twisted portion 39 where the plate-shaped portion 38 closer to the knife blade 2 side than the connected portion 37 is twisted by 90 degrees may be provided after the plate-shaped portion 38 is provided with the connected portion 37 provided with the female screw in the right-left direction, a bent portion 40 bent in the Z (up-down) direction may be made between the twisted portion 39 and the connected portion 37, and the connected portion 37 and the connecting portion 36 may be provided so as to be detachable in the front-rear direction of the longitudinal direction X.

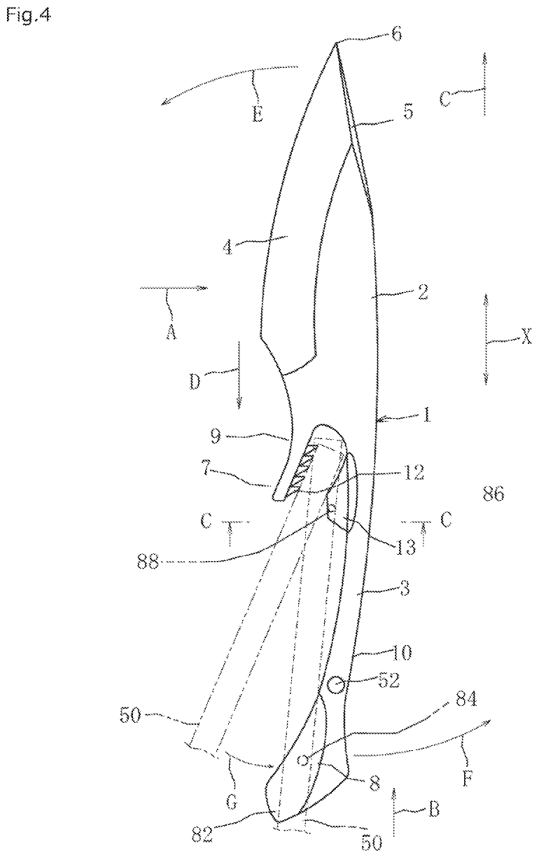

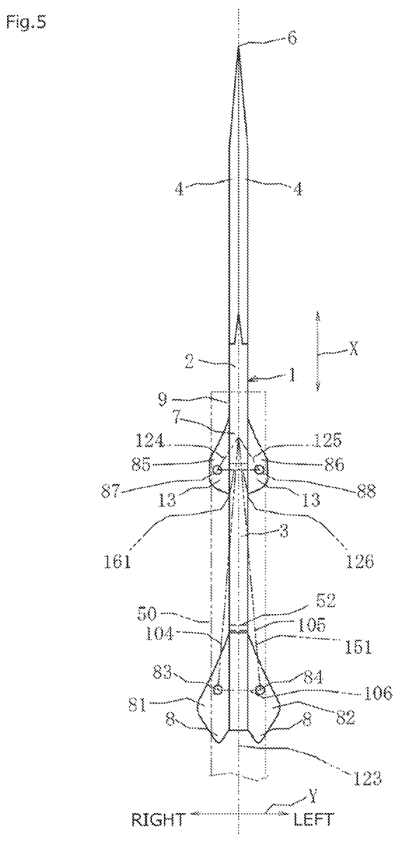

The knife 1 according to a second embodiment illustrated in FIG. 4 exemplifies a spear knife used like a spear with the haft 50 attached, and the knife blade 2 and the tang 3 are integrated in a plate shape. The only difference between the first and second embodiments is that the protrusion portion 7 and the tang 3 are provided with a second receiving portion 13 in the second embodiment. In addition, as illustrated in FIG. 5, the blade 4 and the protrusion portion 7 are provided on the center line 103. Since the blade 4 and the protrusion portion 7 are disposed in a straight line, even in a case where a piercing-direction force is applied to the knife 1, the force can be transmitted to the haft 50 via the protrusion portion 7 without deviating in the right-left direction.

The second receiving portion 13 receiving the haft 50 jointly with the protrusion portion 7 is provided on the side of the tang 3 that faces the protrusion portion 7 above. On the rear side of the tang 3, the first receiving portion 8 is provided to receive the haft 50 with the protrusion portion 7 biting into the haft 50. The second receiving portion 13 is provided with a second right side receiving portion 85 and a second left side receiving portion 86. The second right side receiving portion 85 is provided with a second right protrusion portion 87. The second left side receiving portion 86 is provided with a second left protrusion portion 88. As for the second receiving portion 13, the second right side receiving portion 85 and the second left side receiving portion 86 form a set of two. The second right protrusion portion 87 is provided at a position to the right of the blade 4 and the protrusion portion 7. In addition, the second left protrusion portion 88 is provided at a position to the left of the blade 4 and the protrusion portion 7. The second right protrusion portion 87 and the second left protrusion portion 88 are provided so as to be bilaterally symmetrical with respect to the center line 103.

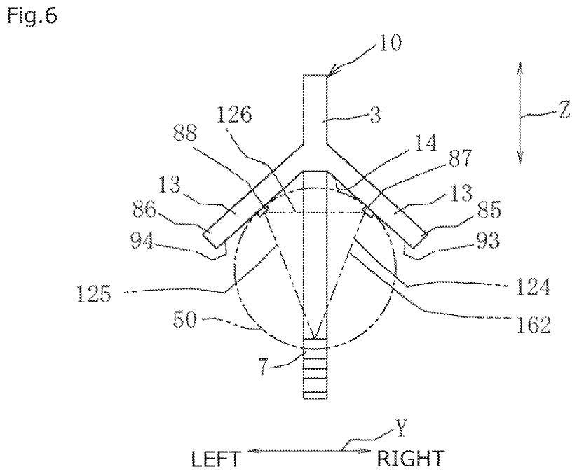

As illustrated in FIG. 6, the second receiving portion 13 protruding on both the right and left sides of the tang 3 is opened downward from the tang 3 side to the protrusion side. A downward recess portion 14 is formed as a result. The recess portion 14 is capable of supporting the haft 50 so as not to sway in the right-left direction.

Returning to FIG. 4, a case where the haft 50 is attached to the knife 1 will be described. The other end portion side of the haft 50 is pushed and moved to the tang 3 side (arrow G direction) with the part where one end portion of the haft 50 is diagonally inserted from below into the space between the protrusion portion 7 and the second receiving portion 13 serving as a fulcrum. In other words, by the haft 50 changing from the aspect indicated by the virtual line to the aspect indicated by the dotted line, one end portion of the haft 50 is sandwiched between the protrusion portion 7 and the second receiving portion 13 from above and below and bitten by the protrusion portion 7. With the protrusion portion 7 biting into the haft 50, the other end portion side of the haft 50 is received by the first receiving portion 8. As a result, the second right protrusion portion 87, the second left protrusion portion 88, the first right protrusion portion 83, and the first left protrusion portion 84 bite into the peripheral surface of the haft 50. The haft 50 is attached to the tang 3 in this state, and thus a structure for connecting the tang 3 and the protrusion portion 7 to the haft 50 is unnecessary and a person using the knife 1 can easily replace the haft 50 to suit his or her preference and purpose of use. A rod with a non-smooth peripheral surface such as a tree branch can be used for the haft 50. As for the thickness of the haft 50, no precise dimensional thickness is required and there is a degree of freedom in terms of the thickness of the tree branch attached to the knife 1.

A bottom-view triangle 161 drawn by a virtual line 124 connecting the protrusion portion 7 and the second right protrusion portion 87, a virtual line 125 connecting the protrusion portion 7 and the second left protrusion portion 88, and a virtual line 126 connecting the second right protrusion portion 87 and the second left protrusion portion 88 is formed as illustrated in FIG. 5. The knife 1 and the haft 50 are stably fixed by forming the triangle 161 by fixing at the three places of the protrusion portion 7, the second right protrusion portion 87, and the second left protrusion portion 88. It should be noted that the triangle 161 is preferably an isosceles triangle in which the virtual line 124 and the virtual line 125 have the same length. The knife 1 and the haft 50 are evenly fixed in the right-left direction to ensure a stable connection.

Further, as illustrated in FIG. 6, in a case where the knife 1 is viewed from the back surface in the direction of the arrow B illustrated in FIG. 4 and a rear-view triangle 162 drawn by the virtual line 124 connecting the protrusion portion 7 and the second right protrusion portion 87, the virtual line 125 connecting the protrusion portion 7 and the second left protrusion portion 88, and the virtual line 126 connecting the second right protrusion portion 87 and the second left protrusion portion 88 is formed, the haft 50 and the knife 1 are more stably connected, which is preferable, by forming the triangle 162 by fixing at the three places of the protrusion portion 7, the second right protrusion portion 87, and the second left protrusion portion 88. In this case, more stability is ensured than in a case where the protrusion portion 7, the second right protrusion portion 87, and the second left protrusion portion 88 are disposed so as to be arranged in a straight line in the right-left direction. The rear-view triangle 162 is preferably an isosceles triangle.

In addition, in the protrusion portion 7 and the first receiving portion 8, the bottom-view triangle 151 and/or the rear-view triangle 152 are formed as described in Paragraphs 0013 to 0019 of the first embodiment.

The second right side receiving portion 85 and the second left side receiving portion 86 of the second receiving portion 13 protrude from the tang 3 on both the right and left sides and are bilaterally symmetrical with respect to a center line 123 as illustrated in FIG. 5. Further, a case where the second right protrusion portion 87 and the second left protrusion portion 88 are provided at positions bilaterally symmetrical with respect to the center line 123 is exemplified.

However, the second right side receiving portion 85 and the second left side receiving portion 86 may protrude from positions deviating forward and backward in the longitudinal direction X. Even in such a case, the bottom-view triangle 161 drawn by the virtual line 124, the virtual line 125, and the virtual line 126 is an isosceles triangle, which is more preferable, if the second right protrusion portion 87 and the second left protrusion portion 88 are provided at positions bilaterally symmetrical with respect to the center line 103. By providing the second right protrusion portion 87 and the second left protrusion portion 88, the contact part between the peripheral surface of the haft 50 and the knife 1 can be identified. Then, the vertex parts of the bottom-view triangle 161 and the rear-view triangle 162 can be determined even in a case where a rod with a non-smooth peripheral surface such as a tree branch fallen outdoors is used for the haft 50.

In addition, a surface 93 of the second right side receiving portion 85 on the side of contact with the haft 50 and a surface 94 of the second left side receiving portion 86 on the side of contact with the haft 50, which are illustrated in FIG. 6, may be flat surfaces without providing the second right protrusion portion 87 and the second left protrusion portion 88. In another structure, the flat surface of the second right side receiving portion 85 on the side of contact with the haft 50 may be in contact with the peripheral surface of the haft 50, the flat surface of the second left side receiving portion 86 on the side of contact with the haft 50 may be in contact with the peripheral surface of the haft 50, and the second receiving portion 13 may be capable of receiving the haft 50 evenly in the right-left direction. In other words, the same structure as a holder for a cylindrical body such as a round bar called a V block or a bevel stand may be used as the second receiving portion 13. Even in such a case, if the contact part between the haft 50 and the surface 93 of the second right side receiving portion 85 on the side of contact with the haft 50 is on the side to the right of the blade 4 and the protrusion portion 7 and the contact part between the haft 50 and the surface 94 of the second left side receiving portion 86 on the side of contact with the haft 50 is on the side to the left of the blade 4 and the protrusion portion 7, the bottom-view triangle 161 and the rear-view triangle 162 are formed at the three places of the two contact parts and the protrusion portion 7. As a result, the knife 1 and the haft 50 can be connected and a stable connection is possible.

The protrusion portion 7 may bite into the end surface of the tip of the wooden rod that becomes the haft 50, and there is no need for the haft 50 to be provided with a special structure or processing for attaching the knife 1. It should be noted that application is possible even in a case where the second right side receiving portion 85 and the second left side receiving portion 86 of the second receiving portion 13 protrude from positions deviating forward and backward in the longitudinal direction X.

In FIG. 4, a tooth portion 12 is provided on the outer surface of the protrusion portion 7 so as to face the second receiving portion 13. Accordingly, in a case where the other end portion side of the haft 50 is pushed and moved to the tang 3 side (arrow G direction) with the part where one end portion of the haft 50 is diagonally inserted from below into the space between the protrusion portion 7 and the second receiving portion 13 serving as a fulcrum, the tooth portion 12 bites into the outer surface of one end portion of the haft 50 to prevent slipping. As a result, the haft 50 is unlikely to be disconnected from the protrusion portion 7 and the push and movement of the other end portion side of the haft 50 to the tang 3 side is improved.

If both the tang 3 and the haft 50 are tied together from the outside by the tying member 51 such as a string and a rope with the haft 50 supported by the protrusion portion 7, the first receiving portion 8, and the second receiving portion 13 and attached to the tang 3 as described above, fixing can be performed with the second right protrusion portion 87, the second left protrusion portion 88, the first right protrusion portion 83, and the first left protrusion portion 84 biting. As a result, the attachment of the haft 50 to the tang 3 is stable. In a case where both the haft 50 and the tang 3 are tied by the tying member 51 in this manner, one end portion of the haft 50 is supported by the protrusion portion 7 and the second receiving portion 13 and temporarily fixed, and thus both the haft 50 and the tang 3 are easily tied by the tying member 51.

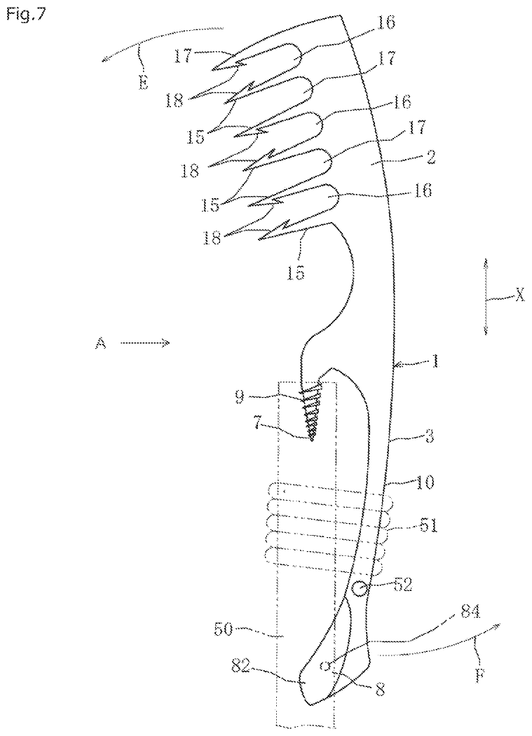

The knife 1 according to a third embodiment illustrated in FIG. 7 exemplifies a hunting tool that swings sideways to catch prey that is an aquatic organism or a terrestrial organism. As for the knife 1, the knife blade 2, the tang 3 extending from one end portion of the knife blade 2 in the longitudinal direction X of the knife blade 2, and a plurality of harpoon tips 15 protruding laterally from one side portion of the knife blade 2 are integrated in a plate shape. The structure of the tang 3 is the same in the first and third embodiments, and the knife 1 is fixed to the haft 50 by the structure of the protrusion portion 7 and the first receiving portion 8.

Although the number of the harpoon tips 15 is not limited to six, six are exemplified. A first interval part 16 and a second interval part 17 are exemplified as interval parts. An aspect in which the first interval part 16 and the second interval part 17 are alternately adjacent in the longitudinal direction X of the knife blade 2 is exemplified.

The first interval part 16 may have a shape lacking a return 18. Even in this case, it is possible to pierce the prey with the plurality of harpoon tips 15 using the centrifugal force in swinging down the knife 1. In addition, although the return 18 may be provided in a shape protruding to the first interval part 16 side from at least one of the harpoon tips 15 at the first interval part 16, an aspect in which the return 18 is provided in a shape protruding to the first interval part 16 side from a pair of the harpoon tips 15 at the first interval part 16 is exemplified, and thus the prey is harder to escape and easier to catch in a case where the return 18 is provided on the pair of harpoon tips 15 at the first interval part 16 than in a case where the return 18 is provided on at least one of the harpoon tips 15 at the first interval part 16. The second interval part 17 is return-less.

In addition, on the front side of the tang 3 extending in the front-rear direction, the protrusion portion 7 capable of biting into the haft 50 made of, for example, a wooden rod such as a tree branch is provided so as to separate from the tang 3 and protrude to the rear side of the tang 3. Although not illustrated, when viewed from the arrow A in FIG. 7, the protrusion portion 7 and the plurality of harpoon tips 15 are provided on a center line. Since the plurality of harpoon tips 15 and the protrusion portion 7 are disposed in a straight line, even in a case where a force is applied to the knife 1, the force does not deviate in the right-left direction.

The structure of the tang 3 of the second embodiment can be applied in the third embodiment. In other words, the outer surface of the protrusion portion 7 provided in front of the tang 3 may be provided with the tooth portion 12 and the second receiving portion 13 may be provided so as to face the tooth portion 12.

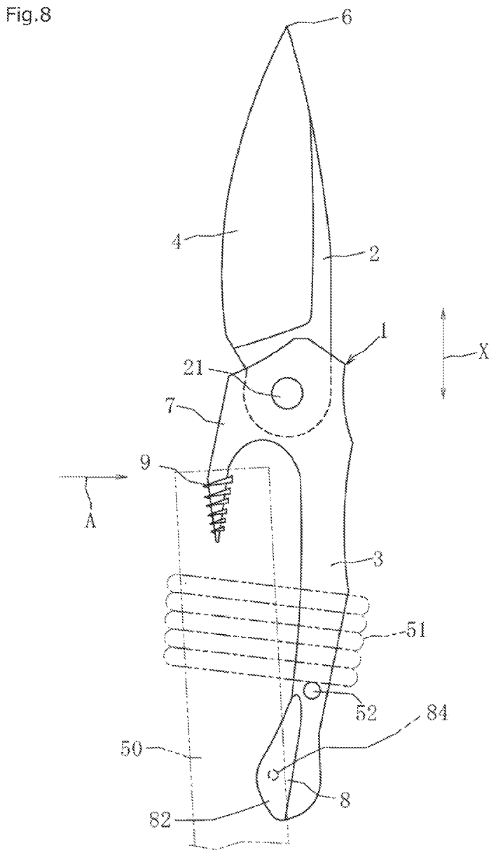

The knife 1 according to a fourth embodiment illustrated in FIG. 8 exemplifies a spear knife used like a spear with the haft 50 attached, and the knife blade 2 and the tang 3 are foldably connected to each other. The knife blade 2 has a plate shape extending from one end portion to the other end portion. The knife blade 2 is provided with the blade 4 as a blade in the lower portion of the knife blade 2 in a direction intersecting with the longitudinal direction X. The knife blade 2 is provided with the point 6 as a cutting edge in one end portion of the knife blade 2 in the longitudinal direction X.

On the front side of the tang 3 extending in the front-rear direction, the protrusion portion 7 capable of biting into the haft 50 made of, for example, a wooden rod such as a tree branch is provided so as to separate from the tang 3 and protrude to the rear side of the tang 3. On the rear side of the tang 3, the first receiving portion 8 receiving the haft 50 with the protrusion portion 7 biting into the haft 50 is provided. Accordingly, the end surface of one end portion of the haft 50 is bitten by being pushed in from the protruding end side of the protrusion portion 7 toward the front side of the tang 3. With the protrusion portion 7 biting into the haft 50, the other end portion side of the haft 50 is received by the first receiving portion 8. As a result, the haft 50 is attached to the knife 1. As a result, a structure for connecting the tang 3 and the protrusion portion 7 to the haft 50 is unnecessary and a person using the knife 1 can easily replace the haft 50 to suit his or her preference and purpose of use.

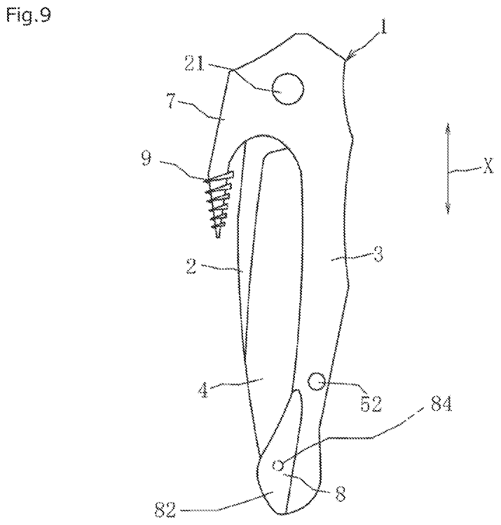

In addition, the knife blade 2 and the tang 3 are mutually foldable with a shaft 21 serving as the center of rotation in the unfolded state in FIG. 8 where the other end portion of the knife blade 2 and one end portion on the front side of the tang 3 are connected by the shaft 21 and the blade 4 of the knife blade 2 linearly protrudes from the tang 3 to the front side with the shaft 21 serving as the center of rotation and the folded state in FIG. 9 where the blade 4 of the knife blade 2 is overlapped on the tang 3 side via the protrusion portion 7 of the tang 3.

In the unfolded state illustrated in FIG. 8, the end surface of one end portion of the haft 50 is bitten by being pushed in from the protruding end side of the protrusion portion 7 toward the front side of the tang 3. With the protrusion portion 7 biting into the haft 50, the side of the haft 50 in the other end portion of the tang 3 is received by the first receiving portion 8. As a result, the haft 50 is attached to the knife 1. As a result, a structure for connecting the tang 3 and the protrusion portion 7 to the haft 50 is unnecessary and a person using the knife 1 can easily replace the haft 50 to suit his or her preference and purpose of use.

In addition, in the unfolded state illustrated in FIG. 8, the blade 4 of the knife blade 2 is overlapped on the tang 3 side via the protrusion portion 7 of the tang 3 from the state where the haft 50 is disconnected from the tang 3. The folded state illustrated in FIG. 9 results therefrom, and the length of the knife 1 according to the fourth embodiment illustrated in FIG. 8 can be reduced in the front-rear direction as the longitudinal direction X.

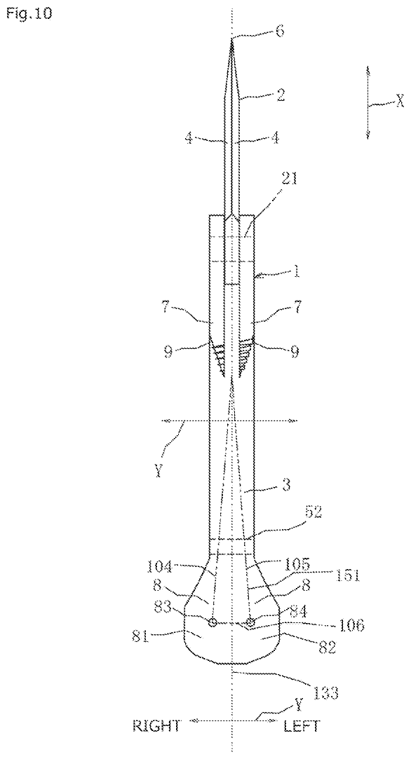

As illustrated in FIG. 10, a pair of the protrusion portions 7 face each other with a gap in the right-left direction of the arrow Y and the knife blade 2 passes through the gap between the pair of protrusion portions 7 facing each other. In the protrusion portion 7 illustrated in FIG. 10, the middle part of one tapered male screw 9 is removed, the knife blade 2 passes through the removed part, and the blade 4 faces the tang 3. In other words, the pair of protrusion portions 7 facing each other in the right-left direction play the role of one tapered male screw 9 in one set. The blade 4 and the protrusion portion 7 are provided in a straight line on a center line 133. Accordingly, even in a case where a piercing-direction force is applied to the knife 1, the force can be transmitted to the haft 50 via the pair of protrusion portions 7 facing each other without deviating in the right-left direction. It should be noted that the protrusion portion 7 may be provided on either the left or right of a pair of protrusions facing each other, the provided protrusion portion 7 may be provided with the male screw 9, and the haft 50 may be screwed onto the male screw 9 of the one protrusion portion 7.

The first receiving portion 8 of the tang 3 according to the first embodiment may be provided as illustrated in FIG. 2 also in the knife 1 according to the fourth embodiment illustrated in FIG. 8. In other words, the same structure as the first receiving portion 8 described in Paragraphs 0013 to 0018 can be applied.

It should be noted that the structure of the tang 3 of the second embodiment may be applied in the knife 1 according to the fourth embodiment illustrated in FIG. 8. In other words, the tooth portion 12 may be applied in place of the male screw 9 in Paragraph 0049 and, as illustrated in FIG. 4, the second receiving portion 13 of the tang 3 according to the second embodiment may be provided. In other words, the second receiving portion 13 may protrude on both the right and left sides of the tang 3 so as to be capable of receiving the haft 50 evenly in the right-left direction as illustrated in FIGS. 4 and 5 or the recess portion 14 may be capable of supporting the haft 50 so as not to sway in the right-left direction with the downward recess portion 14 formed by the second receiving portion 13 protruding on both the right and left sides of the tang 3 being opened downward from the tang 3 side to the protrusion side as illustrated in FIG. 6.

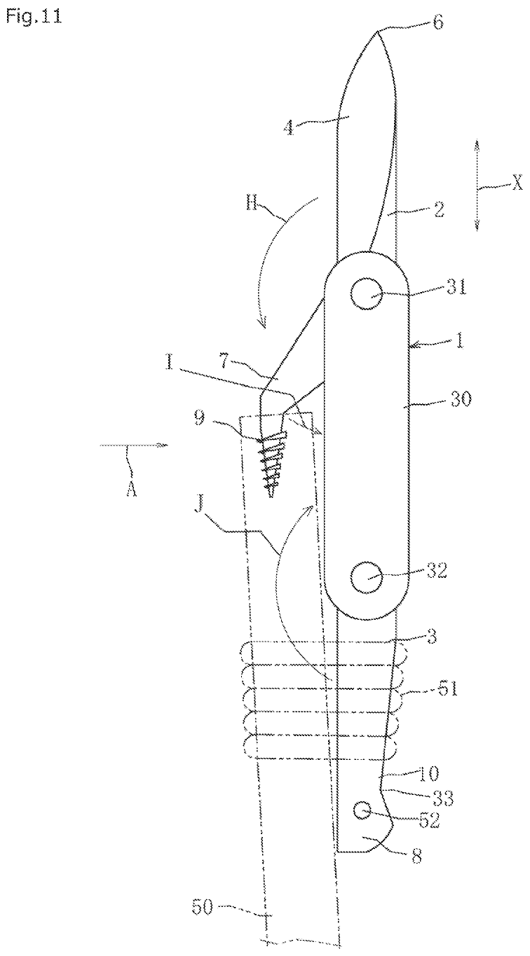

The knife 1 according to a fifth embodiment illustrated in FIG. 11 exemplifies a multipurpose knife, in which the knife blade 2, the tang 3, and the protrusion portion 7 are separate bodies, divided in the front-rear direction, and foldably connected to a sheath portion 30. The knife blade 2 has the shape of a single plate extending from one end portion to the other end portion. The knife blade 2 is provided with the blade 4 as a blade in the lower portion of the knife blade 2 in a direction intersecting with the longitudinal direction X. The knife blade 2 is provided with the point 6 as a cutting edge in one end portion of the knife blade 2 in the longitudinal direction X. The tang 3 has the shape of a single plate extending from one end portion to the other end portion. The protrusion portion 7 has the shape of a single plate bent such that one straight line is bent at one point.

The other end portion of the knife blade 2 and the other end portion of the protrusion portion 7 are coaxially connected to one end portion of the sheath portion 30 by a shaft 31. The shaft 31 serves as the center of rotation for the unfolded state in FIG. 11 where the blade 4 of the knife blade 2 linearly protrudes to the front side from the sheath portion 30 and a folded state where the blade 4 of the knife blade 2 in the unfolded state is rotated in the direction indicated by the arrow H and accommodated in the sheath portion 30 via the lower side from the front side of the sheath portion 30. The knife blade 2 in the unfolded state is held so as to be stopped by a stopper (not illustrated) provided between the knife blade 2 and the sheath portion 30 so as not to rotate in the direction opposite to the direction indicated by the arrow H from the position linearly protruding to the front side from the sheath portion 30.

In the unfolded state illustrated in FIG. 11, one end portion of the protrusion portion 7 protrudes downward from the sheath portion 30 by being bent from one end portion of the sheath portion 30 to the other end portion side. In the folded state, one end portion of the protrusion portion 7 in the unfolded state is rotated in the direction indicated by the arrow I and accommodated in the sheath portion 30 from below the sheath portion 30. The protrusion portion 7 in the unfolded state may or may not rotate in the direction opposite to the direction indicated by the arrow I from the position bent and protruding downward from the sheath portion 30.

One end portion of the tang 3 is connected to the other end portion of the sheath portion 30 by a shaft 32. The shaft 32 is the center of rotation for the unfolded state in FIG. 11 where the other end portion of the tang 3 linearly protrudes to the rear side from the sheath portion 30 and a folded state where the other end portion of the tang 3 in the unfolded state is rotated in the direction indicated by the arrow J and accommodated in the sheath portion 30 via the lower side from the rear side of the sheath portion 30. The tang 3 in the unfolded state may or may not rotate in the direction opposite to the direction indicated by the arrow J from the position linearly protruding to the rear side from the sheath portion 30.

In the unfolded state illustrated in FIG. 11, the end surface of one end portion of the haft 50 is bitten by being pushed in from the protruding end side of the protrusion portion 7 to the knife blade 2 side. With the protrusion portion 7 biting into the haft 50, the other end portion side of the haft 50 is received by the tang 3. As a result, the haft 50 is attached to the knife 1. As a result, a structure for connecting the tang 3 and the protrusion portion 7 to the haft 50 is unnecessary and a person using the knife 1 can easily replace the haft 50 to suit his or her preference and purpose of use.

In FIG. 11, one end portion of the protrusion portion 7 is tapered toward the protrusion side, and thus the protrusion portion 7 easily bites into the end surface of one end portion of the haft 50. In addition, in FIG. 11, the outer surface of the tapered protrusion portion 7 is provided with the male screw 9. Accordingly, in a case where the protrusion portion 7 bites into one end portion of the haft 50, the male screw 9 is screwed and bites inward from the tip of one end portion of the haft 50 like a wood screw or a tapping screw by rotating one or both of the knife 1 and the haft 50. As a result, the haft 50 is unlikely to be disconnected from the protrusion portion 7.

In a case where both the tang 3 and the haft 50 are tied from the outside by the tying member 51 such as a string and a rope with the haft 50 supported by the protrusion portion 7 in the unfolded state and the tang 3 in the unfolded state and attached to the knife 1 as described above, the attachment of the haft 50 to the knife 1 is stable if the protrusion portion 7 in the unfolded state is stopped by a stopper (not illustrated) provided between the protrusion portion 7 and the sheath portion 30 so as not to rotate in the direction opposite to the direction indicated by the arrow I from the position bent and protruding downward from the sheath portion 30 and the tang 3 in the unfolded state is stopped by a stopper (not illustrated) provided between the tang 3 and the sheath portion 30 so as not to rotate in the direction opposite to the direction indicated by the arrow J from the position linearly protruding to the rear side from the sheath portion 30.

In FIG. 11, the tang 3 is not provided with the first receiving portion 8 protruding laterally in the right-left direction illustrated in FIG. 1, and thus the tang 3 is accommodated in the sheath portion 30. When the haft 50 is attached to the knife 1, the contact part between the peripheral surface of the haft 50 and the tang 3 becomes the first receiving portion 8. In addition, the tang 3 may be provided with the first receiving portion 8 protruding in the left-right lateral direction illustrated in FIG. 1 with the structure of the tang 3 of the first embodiment applied. In this case, a part of the first receiving portion 8 may protrude outside the sheath portion 30 when the tang 3 is accommodated in the sheath portion 30. In a case where the first receiving portion 8 is provided, what have been described in Paragraphs 0013 to 0018 are applicable.

A tang 41 (not illustrated) and a tang 42 (not illustrated) that serve as the single tang 3 may be disposed in the gap between two plate-shaped sheath portions 30 in the lateral direction Y, and the protrusion portion 7 may be disposed between the tang 41 and the tang 42. In a case where the haft 50 is attached to the knife 1 in such a case, the bottom-view triangle 151 and the rear-view triangle 152 are formed at the three contact parts between the protrusion portion 7 and the haft 50, between the tang 41 and the haft 50, and between the tang 42 and the haft 50, and thus coupling can be performed with stability. The tang 41 and the tang 42 are provided in a plate shape and can be accommodated in the sheath portion 30.

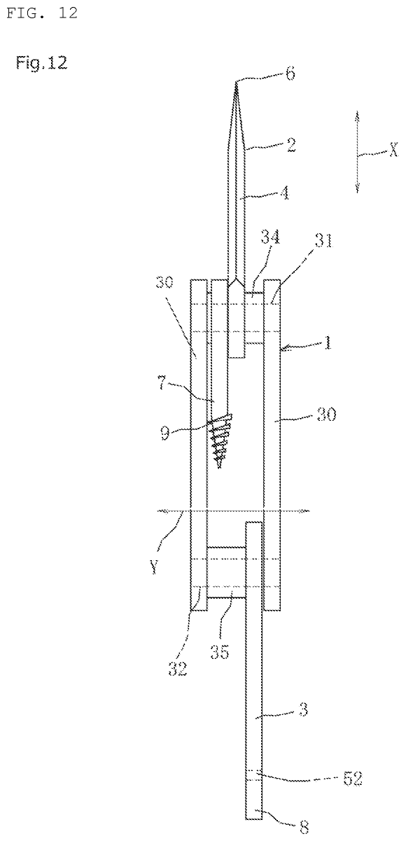

As illustrated in FIG. 12, a pair of plate-shaped sheath portions 30 face each other with a gap in the lateral direction Y. In the gap between the two plate-shaped sheath portions 30 in the lateral direction Y, the knife blade 2, the protrusion portion 7, and a first spacer 34 are disposed so as to be mutually adjacent in the lateral direction Y on the one end portion side of the sheath portion 30 and are foldably connected to the two plate-shaped sheath portions 30 by the shaft 31. The first spacer 34 is a member by which a space accommodating the tang 3 is ensured between the knife blade 2 and the sheath portion 30 that is on the side close to the knife blade 2.

In addition, in the gap between the two plate-shaped sheath portions 30 in the lateral direction Y, the tang 3 and a second spacer 35 are disposed so as to be mutually adjacent in the lateral direction Y on the other end portion side of the sheath portion 30 and are foldably connected to the two plate-shaped sheath portions 30 by the shaft 32. The second spacer 35 is a member by which a space accommodating the knife blade 2 and the protrusion portion 7 is ensured between the tang 3 and the sheath portion 30 that is on the side close to the protrusion portion 7.

It should be noted that how the knife blade 2, the protrusion portion 7, and the first spacer 34 are arranged in the lateral direction Y and how the tang 3 and the second spacer 35 are arranged in the lateral direction Y are not limited to the aspect illustrated in FIG. 12.

The tooth portion 12 illustrated in FIG. 4 may be applied as to the protrusion portion 7. In a case where the tooth portion 12 is applied, the second receiving portion 13 may be provided in the sheath portion 30 so as to face the tooth portion 12. In such a case, the sheath portion 30 is applicable in place of the tang 3 in Paragraphs 0032 to 0037.

A case where one protrusion portion 7 is used and the protrusion portion 7 has the shape of a single plate bent such that one straight line is bent at one point is exemplified in FIG. 12. Alternatively, the blade 4 and the tang 3 may be disposed so as to be sandwiched using two protrusion portions 7 having the shape of a single plate bent such that one straight line is bent at one point. The pair of protrusion portions 7 face each other with a gap in the lateral direction Y, and the blade 4 and the tang 3 pass through the gap between the protrusion portions 7. In addition, as illustrated in FIG. 14, a structure similar to the pair of protrusion portions 7 according to the fourth embodiment facing each other in the lateral direction Y may be provided using two protrusion portions 7 having the shape of a single plate bent such that one straight line is bent at one point.

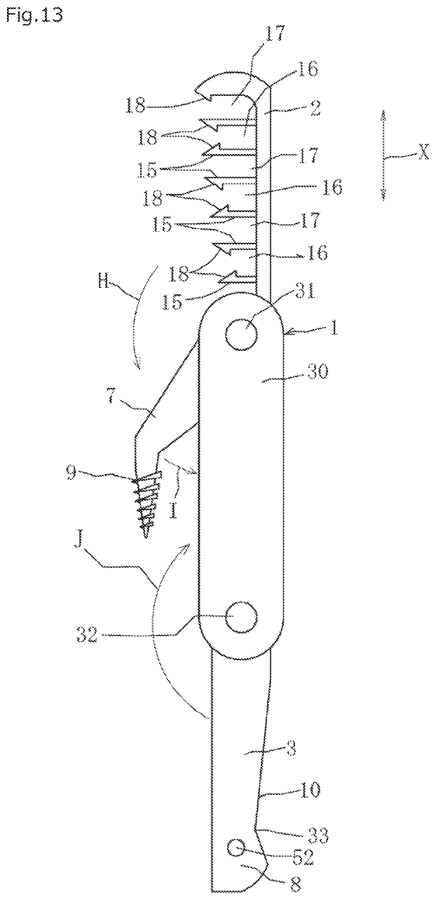

The knife 1 according to a sixth embodiment illustrated in FIG. 13 exemplifies a multipurpose machete, and the knife blade 2 according to the sixth embodiment has the same structure as the knife blade 2 according to the third embodiment. The knife 1 according to the sixth embodiment illustrated in FIG. 13 is the same as the knife 1 according to the fifth embodiment in that the knife blade 2, the tang 3, and the protrusion portion 7 are separate bodies, that the other end portion of the knife blade 2 and the other end portion of the protrusion portion 7 are coaxially connected to one end portion of the sheath portion 30 by the shaft 31 and the shaft 31 is the center of rotation for the unfolded state in FIG. 13 where the harpoon tip 15 of the knife blade 2 linearly protrudes in the lateral direction Y on the front side from the sheath portion 30 and a folded state where the harpoon tip 15 of the knife blade 2 in the unfolded state is rotated in the direction indicated by the arrow H and accommodated in the sheath portion 30 via the lower side from the front side of the sheath portion 30, that one end portion of the protrusion portion 7 protrudes downward from the sheath portion 30 by being bent from one end portion of the sheath portion 30 to the other end portion side in the unfolded state illustrated in FIG. 13 and one end portion of the protrusion portion 7 in the unfolded state is rotated in the direction indicated by the arrow I and accommodated in the sheath portion 30 from below the sheath portion 30 in a folded state, and that one end portion of the tang 3 is connected to the other end portion of the sheath portion 30 by the shaft 32 and the shaft 32 is the center of rotation for the unfolded state in FIG. 13 where the other end portion of the tang 3 linearly protrudes to the rear side from the sheath portion 30 and a folded state where the other end portion of the tang 3 in the unfolded state is rotated in the direction indicated by the arrow J and accommodated in the sheath portion 30 via the lower side from the rear side of the sheath portion 30.

In the second to sixth embodiments, the protrusion portion 7 may be detachable and the description in Paragraph 0024 can be applied.

In addition, in the first to sixth embodiments, the first right protrusion portion 83, the first left protrusion portion 84, the second right protrusion portion 87, and the second left protrusion portion 88 may be tapered toward the protrusion side.

Although the case of the knife 1 where the haft is attached to the knife blade 2 and the tang 3 is exemplified in the first to sixth embodiments of the invention, the invention is not limited to the knife 1. For example, the invention can be applied to various tools to which a haft is attached, examples of which include tableware such as forks and spoons, fishing gears such as nets and harpoons for fishing, and agricultural tools such as scoops and sickles. In other words, the invention is a haft attachment structure.

In the first to sixth embodiments, the knife blade 2 corresponds to a tip member, the tang 3 corresponds to an attachment main body portion, and the knife 1 corresponds to a tool.

In the invention, the tool is configured by the tip member of tableware such as a fork and a spoon being provided with the attachment main body portion. In addition, the tool is configured by the tip member of a fishing gear such as a net and a harpoon for fishing being provided with the attachment main body portion. Further, the tool is configured by the tip member of an agricultural tool such as a scoop and a sickle being provided with the attachment main body portion.

### EXPLANATIONS OF LETTERS OR NUMERALS

1 KNIFE
2 KNIFE BLADE
3 TANG
4 BLADE
5 BLADE
6 POINT
7 PROTRUSION PORTION
8 FIRST RECEIVING PORTION
9 MALE SCREW OF PROTRUSION PORTION 7
10 BACK PORTION OF TANG 3
11 RECESS PORTION OF FIRST RECEIVING PORTION 8
12 TOOTH PORTION OF PROTRUSION PORTION 7
13 SECOND RECEIVING PORTION
14 RECESS PORTION OF SECOND RECEIVING PORTION 13
15 HARPOON TIP
16 FIRST INTERVAL PART
17 SECOND INTERVAL PART
18 RETURN
21 SHAFT
30 SHEATH PORTION
31 SHAFT
32 SHAFT
33 NON-SLIP PORTION
34 FIRST SPACER
35 SECOND SPACER
36 CONNECTING PORTION
37 CONNECTED PORTION
38 PLATE-SHAPED PORTION
39 TWISTED PORTION
40 BENT PORTION
50 HAFT
51 TYING MEMBER
X FRONT-REAR DIRECTION AS LONGITUDINAL DIRECTION OF TANG 3 AND KNIFE BLADE 2
Y RIGHT-LEFT DIRECTION INTERSECTING WITH LONGITUDINAL DIRECTION
Z UP-DOWN DIRECTION INTERSECTING WITH LONGITUDINAL DIRECTION

1.-11. (canceled)

12. A tool comprising a tip member and an attachment main body portion, wherein
a protrusion portion capable of biting into a haft is provided on a front side of the attachment main body portion so as to be separated from the attachment main body portion and protrude to a rear side of the attachment main body portion,
a first receiving portion receiving the haft with the protrusion portion biting into the haft is provided on the rear side of the attachment main body portion,
the protrusion portion is tapered toward the side to which the protrusion portion protrudes, and
a male screw is provided on an outer surface of the protrusion portion.

13. The tool according to claim 12, wherein a connecting portion provided with a male screw protruding in front of the protrusion portion and a connected portion provided with a female screw in a hole recessed forward from a front part of the attachment main body portion are provided.

14. The tool according to claim 13, wherein
a twisted portion is provided by twisting a plate-shaped portion closer to a knife blade side than the connected portion,
a bent portion bent in an up-down direction is created between the twisted portion and the connected portion, and
the connected portion and the connecting portion are provided so as to be detachable in a front-rear direction.

15. The tool according to claim 12, wherein the attachment main body portion is provided with a projecting or recessed non-slip portion for a member tying the haft to the attachment main body portion.

16. The tool according to claim 12, wherein the tip member and the attachment main body portion are foldably connected.

17. A tool comprising a tip member and an attachment main body portion, wherein a protrusion portion capable of biting into a haft is provided on a front side of the attachment main body portion so as to be separated from the attachment main body portion and protrude to a rear side of the attachment main body portion, a first receiving portion receiving the haft with the protrusion portion biting into the haft is provided on the rear side of the attachment main body portion, and the first receiving portion is provided with a first right side receiving portion and a first left side receiving portion protruding from the attachment main body portion on both right and left sides.

18. The tool according to claim 17, wherein the first right side receiving portion is provided with a first right protrusion portion and the first left side receiving portion is provided with a first left protrusion portion.

19. The tool according to claim 17, wherein a surface of the first right side receiving portion on a side of contact with the haft is a flat surface and a surface of the first left side receiving portion on a side of contact with the haft is a flat surface.

20. The tool according to claim 17, wherein
the protrusion portion is tapered toward the side to which the protrusion portion protrudes, and
a male screw is provided on an outer surface of the protrusion portion.

21. The tool according to claim 17, wherein a tooth portion is provided on an outer surface of the protrusion portion.

22. The tool according to claim 21, wherein
a second receiving portion receiving the haft jointly with the protrusion portion is provided on a side of the attachment main body portion facing the protrusion portion, and
the second receiving portion is provided with a second right side receiving portion and a second left side receiving portion protruding from the attachment main body portion on both right and left sides.

23. The tool according to claim 17, wherein the attachment main body portion is provided with a projecting or recessed non-slip portion for a member tying the haft to the attachment main body portion.

24. The tool according to claim 17, wherein the tip member and the attachment main body portion are foldably connected.

25. A tool in which a tip member and an attachment main body portion are divided in a front-rear direction and foldably connected to a sheath portion, wherein a protrusion portion capable of biting into a haft is connected to the sheath portion foldably and coaxially with the tip member and the attachment main body portion is unfolded from the sheath portion so as to receive the haft with the protrusion portion biting into the haft.

26. The tool according to claim 25, wherein the protrusion portion is tapered toward a side to which the protrusion portion protrudes.

27. The tool according to claim 26, wherein a male screw is provided on an outer surface of the protrusion portion.

28. The tool according to claim 25, wherein the attachment main body portion unfolded from the sheath portion is provided with a projecting or recessed non-slip portion for a member tying the haft to the attachment main body portion.
